(19) United States
(12) Patent Application Publication
(10) Pub. No.: US 2026/0118264 A1
(43) Pub. Date: Apr. 30, 2026

(54) CONTROL DEVICE

(71) Applicant: TOYOTA JIDOSHA KABUSHIKI KAISHA, Toyota-shi (JP)

(72) Inventor: Hiroyuki NISHIMURA, Toyota-shi (JP)

(73) Assignee: TOYOTA JIDOSHA KABUSHIKI KAISHA, Toyota-shi (JP)

(21) Appl. No.: 19/245,778

(22) Filed: Jun. 23, 2025

(30) Foreign Application Priority Data
Oct. 25, 2024 (JP) 2024-188323

(51) Int. Cl. G01N 21/3581; G01N 21/3577

(52) U.S. Cl. CPC G01N 21/3581; G01N 21/3577

(57) ABSTRACT

The control device includes an acquisition unit configured to acquire a detection result of a sensor generated by a receiver of the sensor receiving a part of terahertz waves reflected from a road surface while a propagation direction of terahertz waves transmitted from a transmitter of the sensor installed in an underpass changes, and a calculation unit configured to calculate an inundation range of the underpass based on the detection result.

### CROSS-REFERENCE TO RELATED APPLICATION

This application claims priority to Japanese Patent Application No. 2024-188323 filed on Oct. 25, 2024. The disclosure of the above-identified application, including the specification, drawings, and claims, is incorporated by reference herein in its entirety.

### BACKGROUND

### 1. Technical Field

The present disclosure relates to a technical field of a control device.

### 2. Description of Related Art

For example, a device that recognizes the presence or absence of water splashes on surrounding vehicles traveling around a host vehicle and the appearance of bodies of the surrounding vehicles to determine the inundation level of a road has been proposed as this type of device. The appearance of the vehicle bodies of the surrounding vehicles is recognized, for example, from an image captured by an in-vehicle camera. (see Japanese Unexamined Patent Application Publication No. 2021-114102 (JP 2021-114102 A)).

### SUMMARY

There is room for improvement in the technique described in JP 2021-114102 A.

The present disclosure has been made in view of the above circumstances, and an object of the present disclosure is to provide a control device capable of accurately detecting inundation of an underpass.

A control device according to an aspect of the present disclosure includes:

an acquisition unit configured to acquire, with a propagation direction of terahertz waves transmitted from a transmitter of a sensor installed in an underpass being changed, a detection result of the sensor that is generated by a receiver of the sensor receiving a part of terahertz waves reflected from a road surface; and
a calculation unit configured to calculate an inundation range of the underpass based on the detection result.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration of a control device according to an embodiment;

FIG. 2 is a conceptual diagram showing an example of an installation mode of a sensor according to the embodiment;

FIG. 3 is a flowchart showing an example of an operation of the control device according to the embodiment; and

FIG. 4 is a diagram showing an example of a panning angle of the sensor according to the embodiment.

### DETAILED DESCRIPTION OF EMBODIMENTS

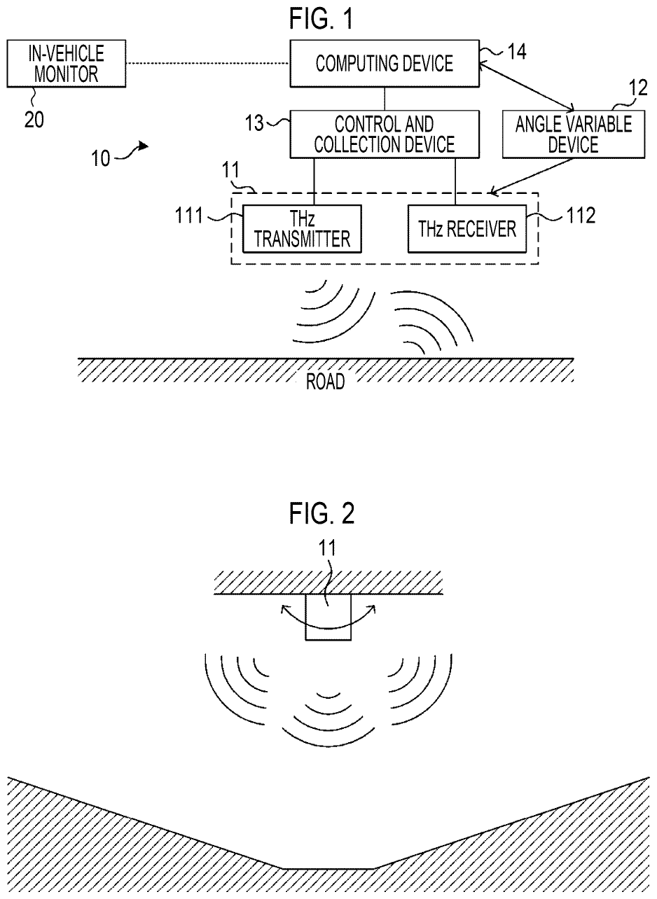

A control device according to an embodiment will be described with reference to FIGS. 1 to 4. In FIG. 1, the control device 10 includes a sensor 11, an angle variable device 12, a control and collection device 13, and a computing device 14. The sensor 11 includes a transmitter 111 for terahertz waves and a receiver 112 for terahertz waves.

As shown in FIG. 2, the sensor 11 may be installed on a ceiling portion of the underpass. The sensor 11 may have a panning mechanism (not shown). The angle variable device 12 may change the propagation direction of the terahertz waves transmitted from the transmitter 111 by controlling the panning mechanism of the sensor 11. For example, the angle variable device 12 may control the panning mechanism of the sensor 11 such that the terahertz waves transmitted from the transmitter 111 scan the underpass in the direction in which the underpass extends.

The control and collection device 13 controls the transmitter 111 to irradiate the road surface of the underpass with the terahertz waves. The receiver 112 receives at least a part of the terahertz waves reflected from the road surface. The control and collection device 13 collects detection information (that is, data) on the detection result of the receiver 112. In other words, the control and collection device 13 acquires the detection result of the sensor 11. The detection information (in other words, the detection result of the sensor 11) may include angle information indicating the panning angle of the sensor 11.

The control and collection device 13 controls the transmitter 111 to irradiate the road surface with the first terahertz wave having the first frequency and the second terahertz wave having the second frequency different from the first frequency. Here, the reflectance of the first terahertz wave from water is equivalent to the reflectance of the first terahertz wave from a dry road surface. The reflectance of the second terahertz wave from water is smaller than the reflectance of the second terahertz wave from the dry road surface. The first frequency may be smaller than the second frequency.

The computing device 14 may include, for example, at least one of a central processing unit (CPU) and a graphics processing unit (GPU). The computing device 14 acquires the detection information from the control and collection device 13. The computing device 14 may calculate a range in the underpass in which water is accumulated (in other words, a range inundated with water), based on the acquired detection information. The computing device 14 may control the angle variable device 12 to change the propagation direction of the terahertz waves transmitted from the transmitter 111.

When rainwater flows into the underpass, the sloped road that is a part of the underpass is also wet with the rainwater. According to the research conducted by the inventors of the present application, the following has been found. The reflectance of the second terahertz wave on a portion of the road where water is accumulated is clearly smaller than the reflectance of the second terahertz wave from a road surface that is wet (that is, a road surface portion where water is not accumulated). This is because the receiver 112 receives a greater amount of the terahertz wave components reflected from the road surface than the terahertz wave components reflected from water. Therefore, the computing device 14 can calculate the range inundated with water based on the detection information.

When the inundation of the underpass is detected based on the calculation result of the computing device 14, the computing device 14 may transmit inundation information indicating that the underpass is inundated to the vehicle traveling around the underpass. The vehicle that receives the inundation information may display the information indicating that the underpass is inundated on the in-vehicle monitor 20 mounted on the vehicle. As a result, the user of the vehicle is notified that the underpass is inundated.

The angle variable device 12 may control the panning mechanism of the sensor 11 such that the terahertz waves transmitted from the transmitter 111 scan the underpass in the width direction of the underpass. In this case, the terahertz waves transmitted from the transmitter 111 may be irradiated on the road surface of the underpass as well as on the side wall of the underpass.

For example, the panning angle of the sensor 11 when the propagation direction of the terahertz waves transmitted from the transmitter 111 is perpendicular to the road surface of the underpass is set to 0 degrees. Further, for example, the panning angle of the sensor 11 when the propagation direction of the terahertz waves transmitted from the transmitter 111 is perpendicular to one side wall of the underpass is set to 90 degrees. When the underpass is inundated, a part of the side wall is immersed in water. In this case, in a relatively small range of the panning angle of the sensor 11, the reflectance of the second terahertz wave is the same as the reflectance of the second terahertz wave from water. In addition, in a relatively large range of the panning angle of the sensor 11, the reflectance of the second terahertz wave is the same as the reflectance of the second terahertz wave from the dry road surface.

Therefore, the inundation of the underpass can be detected from the range of the panning angle of the sensor 11 in which the reflectance of the second terahertz wave is the same as the reflectance of the second terahertz wave from water. In addition, when the relationship between the panning angle of the sensor 11 and the height of the side wall of the underpass is known, the water depth in the inundated underpass can be specified from the panning angle of the sensor 11. The water entering the underpass along the side walls of the underpass is relatively small. Therefore, when the terahertz waves transmitted from the transmitter 111 scan the underpass in the width direction of the underpass, the inundation of the underpass can be more accurately detected.

The angle variable device 12 may control the panning mechanism of the sensor 11 such that the terahertz waves transmitted from the transmitter 111 scan the underpass in the direction in which the underpass extends and scan the underpass in the width direction of the underpass.

### Operation of Control Device

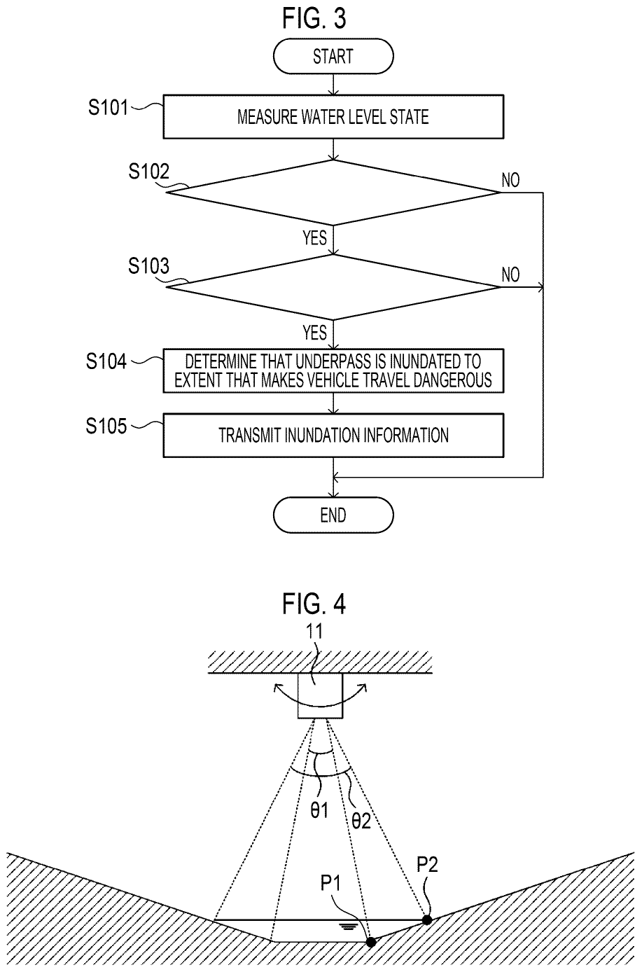

Next, an example of the operation of the control device 10 will be described with reference to the flowchart of FIG. 3. In FIG. 3, the control device 10 measures the water level state of the underpass by using the sensor 11 (S101). Specifically, the control and collection device 13 controls the transmitter 111 to irradiate the road surface of the underpass with the terahertz waves and collects detection information on the detection result of the receiver 112. In this case, the angle variable device 12 controls the panning mechanism of the sensor 11, so that the receiver 112 receives a part of terahertz waves reflected from the road surface, while the propagation direction of the terahertz waves transmitted from the transmitter 111 changes.

The computing device 14 determines, based on the detection information, whether the reflectance of the first terahertz wave is the first predetermined value and the reflectance of the second terahertz wave is equal to or less than the second predetermined value, when the panning angle of the sensor 11 is θ1 (see FIG. 4) (S102). Here, the second predetermined value is a value smaller than the first predetermined value. The second predetermined value may be a value between the reflectance of the second terahertz wave from water and the reflectance of the second terahertz wave from a dry road surface. The reflectance of the terahertz waves may be calculated based on the intensity of the terahertz waves transmitted from the transmitter 111 and the intensity of the terahertz waves received by the receiver 112.

In the process of S102, when the panning angle is θ1 and it is determined that the reflectance of the first terahertz wave is not the first predetermined value, the operation shown in FIG. 3 ends. Alternatively, in the process of S102, when the panning angle is θ1 and it is determined that the reflectance of the second terahertz wave is not equal to or less than the second predetermined value (S102: No), the operation shown in FIG. 3 ends.

In the process of S102, when the panning angle is θ1 and it is determined that the reflectance of the first terahertz wave is the first predetermined value and the reflectance of the second terahertz wave is equal to or less than the second predetermined value (S102: Yes), the computing device 14 executes the process of S103. In the process of S103, the computing device 14 determines, based on the detection information, whether the reflectance of the first terahertz wave is the first predetermined value and the reflectance of the second terahertz wave is equal to or less than the second predetermined value, when the panning angle of the sensor 11 is θ2 (see FIG. 4) (S103).

In the process of S103, when the panning angle is θ2 and it is determined that the reflectance of the first terahertz wave is not the first predetermined value, the operation shown in FIG. 3 ends. Alternatively, in the process of S103, when the panning angle is θ2 and it is determined that the reflectance of the second terahertz wave is not equal to or less than the second predetermined value (S103: No), the operation shown in FIG. 3 ends.

In the process of S103, when the panning angle is θ2, there is a case where it is determined that the reflectance of the first terahertz wave is the first predetermined value and the reflectance of the second terahertz wave is equal to or less than the second predetermined value (S103: Yes). In that case, the computing device 14 determines that the underpass is inundated to the extent that makes vehicle travel dangerous (step S104). The computing device 14 may transmit inundation information indicating that the underpass is inundated to the vehicle traveling around the underpass (S105). After the process of S103, the process of S102 may be performed.

### Technical Effect

The control device 10 detects a portion of the road surface of the underpass in which water is accumulated by using the terahertz waves. For example, the control device 10 can detect inundation with high accuracy compared to determining whether the underpass is inundated by using the image of the underpass.

As shown in FIG. 4, the height of a position P1 at which the terahertz wave is irradiated when the panning angle of the sensor 11 is θ1 is different from the height of a position P2 at which the terahertz wave is irradiated when the panning angle of the sensor 11 is θ2. Therefore, when it is detected that the water is accumulated at the position P2 (for example, when “Yes” is determined in the process of S103), the water level in the underpass is equivalent to the distance from the bottom of the underpass to the height of the position P2. Therefore, by appropriately setting the panning angle θ2, it is possible to relatively easily detect that the underpass is inundated to the extent that makes vehicle travel dangerous.

### Modification

After the process of S104 described above, the control device 10 may transmit the inundation information to the management center that manages the underpass. In this case, the management center may issue a command to block the entrance and exit of the underpass based on the inundation information. The management center may distribute information indicating that the underpass is inundated to the vehicle located in a predetermined range centered on the underpass.

Aspects of the disclosure derived from the embodiments and the modifications described above will be described below.

A control device according to an aspect of the disclosure includes: an acquisition unit configured to acquire, while a propagation direction of terahertz waves transmitted from a transmitter of a sensor installed in an underpass changes, a detection result of the sensor that is generated by a receiver of the sensor receiving a part of terahertz waves reflected from a road surface; and a calculation unit configured to calculate an inundation range of the underpass based on the detection result. In the embodiment described above, the “control and collection device 13” corresponds to an example of the “acquisition unit”, and the “computing device 14” corresponds to an example of the “calculation unit”.

In an example of the control device, the transmitter may be configured to transmit a first terahertz wave having a first frequency and a second terahertz wave having a second frequency different from the first frequency. Here, a reflectance of the first terahertz wave from water may be equivalent to a reflectance of the first terahertz wave from a dry road surface, and a reflectance of the second terahertz wave from water may be smaller than a reflectance of the second terahertz wave from a dry road surface.

The present disclosure is not limited to the embodiments described above, and may be modified as appropriate within a scope that does not depart from the gist or the idea of the disclosure that can be read from the entirety of the claims and specification, and a control device with such a modification is also included in the technical scope of the disclosure.

What is claimed is:

1. A control device comprising:
an acquisition unit configured to acquire, with a propagation direction of terahertz waves transmitted from a transmitter of a sensor installed in an underpass being changed, a detection result of the sensor that is generated by a receiver of the sensor receiving a part of terahertz waves reflected from a road surface; and
a calculation unit configured to calculate an inundation range of the underpass based on the detection result.

2. The control device according to claim 1, wherein the transmitter is configured to transmit a first terahertz wave having a first frequency and a second terahertz wave having a second frequency different from the first frequency.

3. The control device according to claim 2, wherein:
a reflectance of the first terahertz wave from water is equivalent to a reflectance of the first terahertz wave from a dry road surface; and
a reflectance of the second terahertz wave from water is smaller than a reflectance of the second terahertz wave from a dry road surface.
